(19) United States
(12) Patent Application Publication
(10) Pub. No.: US 2019/0045184 A1
(43) Pub. Date: Feb. 7, 2019

(54) METHOD AND APPARATUS OF ADVANCED INTRA PREDICTION FOR CHROMA COMPONENTS IN VIDEO CODING

(71) Applicant: Media Tek Singapore Pte. Ltd., Singapore (SG)

(72) Inventors: Kai ZHANG, Beijing (CN); Jicheng AN, Beijing City (CN); Han HUANG, Beijing (CN)

(73) Assignee: Media Tek Singapore Pte. Ltd., Singapore (SG)

(21) Appl. No.: 16/073,984

(22) PCT Filed: Jan. 25, 2017
(86) PCT No.: PCT/CN2017/072560

§ 371 Date: Jul. 30, 2018

(30) Foreign Application Priority Data
Feb. 18, 2016 (CN) PCT/CN2016/073998

(51) Int. Cl. H04N 19/11; H04N 19/186; H04N 19/176

(52) U.S. Cl. CPC H04N 19/11; H04N 19/176; H04N 19/186

(57) ABSTRACT

Combined Intra prediction is disclosed. The combined Intra prediction is generated for encoding or decoding of a current chroma block by combining first Intra prediction generated according to the first chroma Intra prediction mode and second Intra prediction generated according to the second chroma Intra prediction mode. The second chroma Intra prediction mode belongs to an Intra prediction mode group excluding any LM mode. Multi-phase Intra prediction for a chroma component of non-444 colour video data is also disclosed. A mode group including at least two LM modes are used for multi-phase Intra prediction, where mapping between chroma samples and corresponding luma samples is different for two LM modes from the mode group. Furthermore, chroma Intra prediction with one or more LM modes using extended neighbouring area to derive LM mode parameters is also disclosed.

### CROSS REFERENCE TO RELATED APPLICATIONS

The present invention claims priority to PCT Patent Application, Serial No. PCT/CN2016/073998, filed on Feb. 18, 2016. The PCT Patent Applications is hereby incorporated by reference in its entirety.

### TECHNICAL FIELD

The invention relates generally to video coding. In particular, the present invention relates to chroma Intra prediction using combined Intra prediction modes, extended neighbouring chroma samples and corresponding luma samples for deriving the linear model prediction parameters, or extended linear model prediction modes.

### BACKGROUND

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). The CTU is further partitioned into multiple coding units (CUs) to adapt to various local characteristics. HEVC supports multiple Intra prediction modes and for Intra coded CU, the selected Intra prediction mode is signalled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

HEVC uses more sophisticated Intra prediction than previous video coding standards such as AVC/H.264. According to HEVC, 35 Intra prediction modes are used for the luma components, where the 35 Intra prediction modes include DC, planar and various angular prediction modes. For the chroma component, linear model prediction mode (LM mode) is developed to improve the coding performance of chroma components (e.g. U/V components or Cb/Cr components) by exploring the correlation between the luma (Y) component and chroma components.

In the LM mode, a linear model is assumed between the values of a luma sample and a chroma sample as shown in eq. (1):

C=a*Y+b, (1)

where C represents the prediction value for a chroma sample; Y represents the value of the corresponding luma sample ; and a and b are two parameters.

For some colour sampling formats such as 4:2:0 or 4:2:2, samples in the chroma component and the luma component are not in a 1-1 mapping. FIG. 1 illustrates an example of chroma component (shown as triangles) and corresponding luma samples (shown as circles) for a 4:2:0 colour format.

In LM mode, an interpolated luma value is derived and the luma interpolated value is used to drive a prediction value for a corresponding chroma sample value. In FIG. 1, the interpolated luma value Y is derived according to Y=(YO+Y1)/2. This interpolated luma value Y is used to derive the prediction for the corresponding chroma sample C.

Parameters a and b are derived based on previously decoded luma and chroma samples from top and left neighbouring area. FIG. 2 illustrates an example of the neighbouring samples of a 4×4 chroma block 210 for a 4:2:0 colour format, in which the chroma components are shown as triangles. For the 4:2:0 colour format, this 4×4 chroma is collocated with a corresponding 8×8 luma block, where the luma samples are shown as circles.

There are several extensions of the LM mode. In one extension, parameters a and b are derived from top neighbouring decoded luma and chroma samples only. FIG. 3 illustrates an example of deriving parameters a and b based on the top neighbouring samples of a 4×4 chroma block 310. This extended LM mode is called LM_TOP mode.

In another extension, parameters a and b are derived from left decoded neighbouring luma and chroma samples only. FIG. 4 illustrates an example of deriving parameters a and b based on the left neighbouring samples of a 4×4 chroma block 410. This extended LM mode is called LM_LEFT mode.

In still another extension, a linear model is assumed between values of a sample of a first chroma component (e.g. Cb) and a sample of a second chroma component (e.g. Cr) as shown in eq. (2):

C₁=a*C₂+b, (2)

where C₁ represents the prediction value for a sample of the first chroma component (e.g. Cr); C₂ represents the value of the corresponding sample of the second chroma component (e.g. Cb); a and b are two parameters, which are derived from top and left neighbouring samples of the first chroma component and corresponding samples of the second chroma component. This extended LM mode is called LM_CbCr.

Although LM and its extended modes can improve coding efficiency significantly, it is desirable to further improve the coding efficiency of chroma Intra prediction.

### SUMMARY

A method and apparatus of Intra prediction for a chroma component performed by a video coding system are disclosed. According to this method, combined Intra prediction is generated for encoding or decoding of a current chroma block by combining first Intra prediction generated according to the first chroma Intra prediction mode and second Intra prediction generated according to the second chroma Intra prediction mode. The first chroma Intra prediction mode corresponds to a linear-model prediction mode (LM mode) or an extended LM mode. The second chroma Intra prediction mode belongs to an Intra prediction mode group, where the Intra prediction mode group excludes any linear model prediction mode (LM mode) that generates a chroma prediction value based on a reconstructed luma value using a linear model.

The combined Intra prediction can be generated using a weighted sum of the first Intra prediction and the second Intra prediction. The combined Intra prediction can be calculated using integer operations including multiplication, addition and arithmetic shift to avoid a need for a division operation. For example, the combined Intra prediction can be calculated using a sum of the first Intra prediction and the second Intra prediction followed by a right-shift by one operation. In one example, the weighting coefficient of the weighted sum is position dependent.

In one embodiment, the first chroma Intra prediction mode corresponds to an extended LM mode. For example, the extended LM mode belongs to a mode group including LM_TOP mode, LM_LEFT mode, LM_TOP_RIGHT mode, LM_RIGHT mode, LM_LEFT_BOTTOM mode, LM_BOTTOM mode, LM_LEFT_TOP mode and LM_CbCr mode. On the other hand, the second chroma Intra prediction mode belongs to a mode group including angular modes, DC mode, Planar mode, Planar_Ver mode, Planar_Hor mode, a mode used by a current luma block, a mode used by a sub-block of the current luma block, and a mode used by a previous processed chroma component of the current chroma block.

In another embodiment, a fusion mode can be included in an Intra prediction candidate list, where the fusion mode indicates that the first chroma Intra prediction mode and the second chroma Intra prediction mode are used and the combined Intra prediction is used for the encoding or decoding of the current chroma block. The fusion mode is inserted in a location of the Intra prediction candidate list after all LM modes, where a codeword of the fusion mode is not shorter than the codeword of any LM mode. Furthermore, chroma Intra prediction with a fusion mode can be combined with multi-phase LM modes. In the multi-phase LM modes, mapping between chroma samples and corresponding luma samples is different between a first LM mode and a second LM mod. The first LM mode can be inserted into the Intra prediction candidate list to replace a regular LM mode, and the second LM mode can be inserted into the Intra prediction candidate list at a location after the regular LM mode and the fusion mode.

A method and apparatus of Intra prediction for a chroma component of non-444 colour video data performed by a video coding system are also disclosed. A mode group including at least two linear-model prediction modes (LM modes) are used for multi-phase Intra prediction, where mapping between chroma samples and corresponding luma samples is different for two LM modes from the mode group. For a 4:2:0 colour video data, each chroma sample has four collocated luma samples Y0, Y1, Y2 and Y3 located above, below, above-right, and below-right of each current chroma sample respectively. The corresponding luma sample associated with each chroma sample may correspond to Y0, Y1, Y2, Y3, (Y0+Y1)/2, (Y0+Y2)/2, (Y0+Y3)/2, (Y1+Y2)/2, (Y1+Y3)/2, (Y2+Y3)/2, or (Y0+Y1+Y2+Y3)/4. For example, the mode group may include a first LM mode and a second LM mode, and the corresponding luma sample associated with each chroma sample corresponds to Y0 and Y1 for the first LM mode and the second LM mode respectively.

Yet another method and apparatus of Intra prediction for a chroma component performed by a video coding system are disclosed. According to this method, parameters of a linear model are determined based on neighbouring decoded chroma samples and corresponding neighbouring decoded luma samples from one or more extended neighbouring areas of the current chroma block. The extended neighbouring areas of the current chroma block include one or more neighbouring samples outside an above neighbouring area of the current chroma block or outside a left neighbouring area of the current chroma block. For example, the extended neighbouring areas of the current chroma block may correspond to top and right, right, left and bottom, bottom, or left top neighbouring chroma samples and corresponding luma samples.

### BRIEF DESCRIPTION OF DRAWINGS

FIG. 1 illustrates an example of chroma component (shown as triangles) and luma samples (shown as circles) for a 4:2:0 colour format, where the corresponding luma sample is derived according to Y=(Y0+Y1)/2.

FIG. 2 illustrates an example of the neighbouring samples of a 4×4 chroma block for a 4:2:0 colour format.

FIG. 3 illustrates an example of deriving parameters a and b based on the extended top neighbouring samples of a 4×4 chroma block.

FIG. 4 illustrates an example of deriving parameters a and b based on the extended left neighbouring samples of a 4×4 chroma block.

FIG. 5 illustrates an example of LM_TOP_RIGHT mode for a 4×4 chroma block.

FIG. 6 illustrates an example of LM_TOP_RIGHT mode for a 4×4 chroma block.

FIG. 7 illustrates an example of LM_LEFT_BOTTOM mode for a 4×4 chroma block.

FIG. 8 illustrates an example of LM_BOTTOM mode for a 4×4 chroma block.

FIG. 9 illustrates an example of LM_LEFT_TOP mode for a 4×4 chroma block.

FIG. 10 illustrates an example of the Fusion mode prediction process, where the Fusion mode prediction is generated by linearly combining mode L prediction and mode K prediction with respective weighting factors, w1 and w2.

FIG. 11 illustrates an exemplary sub-block in the current block, where the Intra prediction mode of sub-block for the luma component is used as the mode K Intra prediction for deriving the Fusion mode prediction.

FIG. 12 illustrates an example of a current chroma sample (C) and four associated luma samples (Y0, Y1, Y2, and Y3) for a 4:2:0 color format.

FIG. 13 illustrates an example of code table ordering, where the “Corresponding U mode (For V only)” mode is inserted into the beginning location of the code table and “Other modes in a default order” is inserted at the end of the code table.

FIG. 14 illustrates another example of code table ordering by replacing the LM mode with the LM_Phase1 mode and inserting the LM_Phase2 mode after LM fusion modes.

FIG. 15 illustrates an exemplary flowchart for fusion mode Intra prediction according to an embodiment of the present invention.

FIG. 16 illustrates an exemplary flowchart for multi-phase Intra prediction according to an embodiment of the present invention.

FIG. 17 illustrates an exemplary flowchart for Intra prediction using extended neighbouring area according to an embodiment of the present invention.

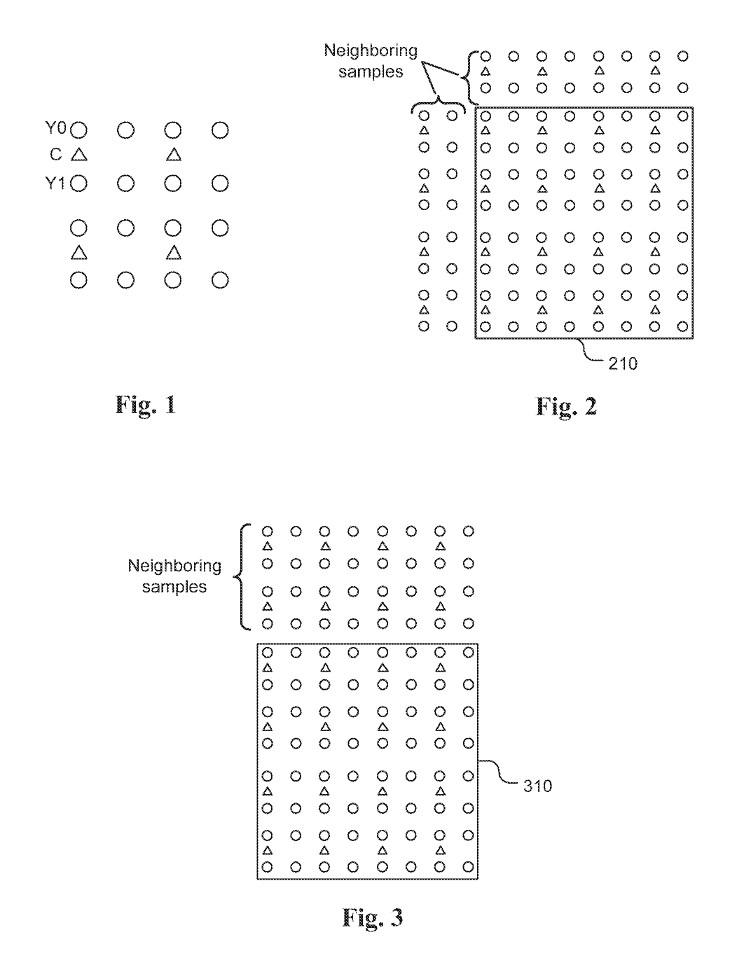

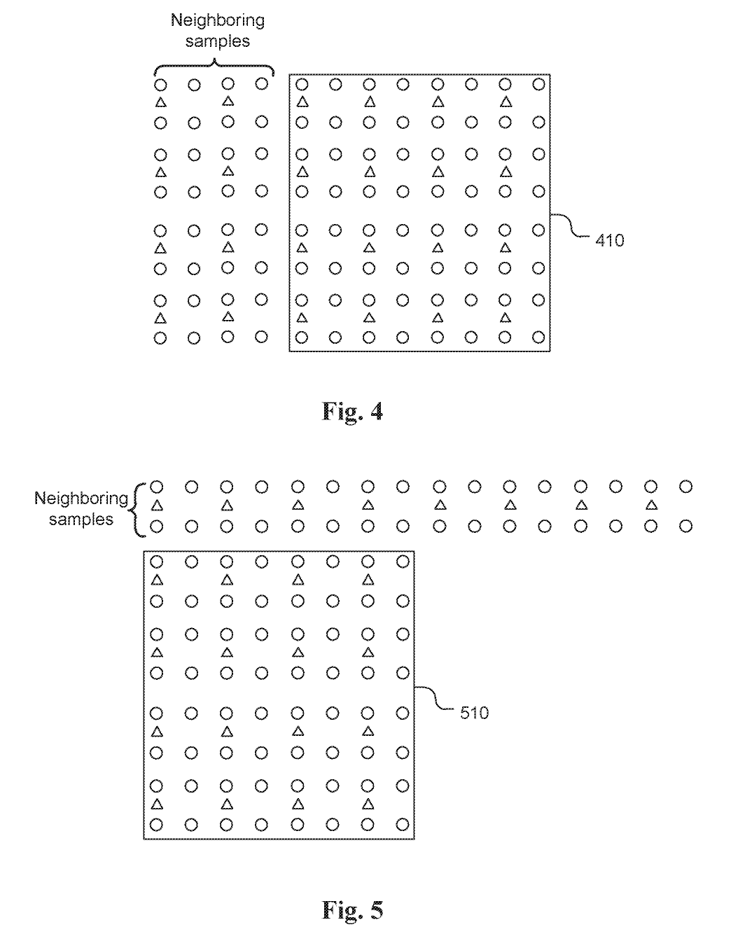

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

In the following description, Y component is identical to the luma component, U component is identical to Cb component and V component is identical to Cr component.

In the present invention, various advanced LM prediction modes are disclosed. In some embodiments, parameters a and b are derived from extended neighbouring area(s) of the current chroma block and/or extended neighbouring area(s) of the corresponding luma block. For example, the top and right neighbouring chroma samples and corresponding luma samples can be used to derive parameters a and b. This extended mode is called LM_TOP_RIGHT mode. FIG. 5 illustrates an example of LM_TOP_RIGHT mode for a 4×4 chroma block 510. As shown in FIG. 5, the “top and right” neighbouring chroma samples (shown as triangles) and corresponding luma samples (shown as circles) refer to the top area on the top of the current chroma block 510 and the area extending to the right from the top area in this disclosure. The use of extended neighbouring area(s) can derive better parameters a and b and to achieve better Intra prediction. Accordingly, the coding performance for chroma Intra prediction using extended neighbouring area(s) can be improved.

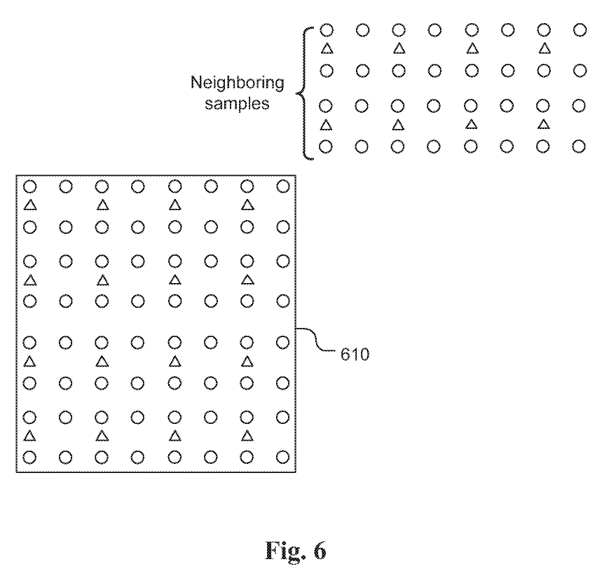

In another embodiment, parameters a and b are derived from right neighbouring chroma samples and corresponding luma samples. This extended mode is called LM_RIGHT mode. FIG. 6 illustrates an example of LM_TOP_RIGHT mode for a 4×4 chroma block 610. As shown in FIG. 6, the “right” neighbouring chroma samples (shown as triangles) and corresponding luma samples (shown as circles) refer to the area extending to the right from the top area in this disclosure.

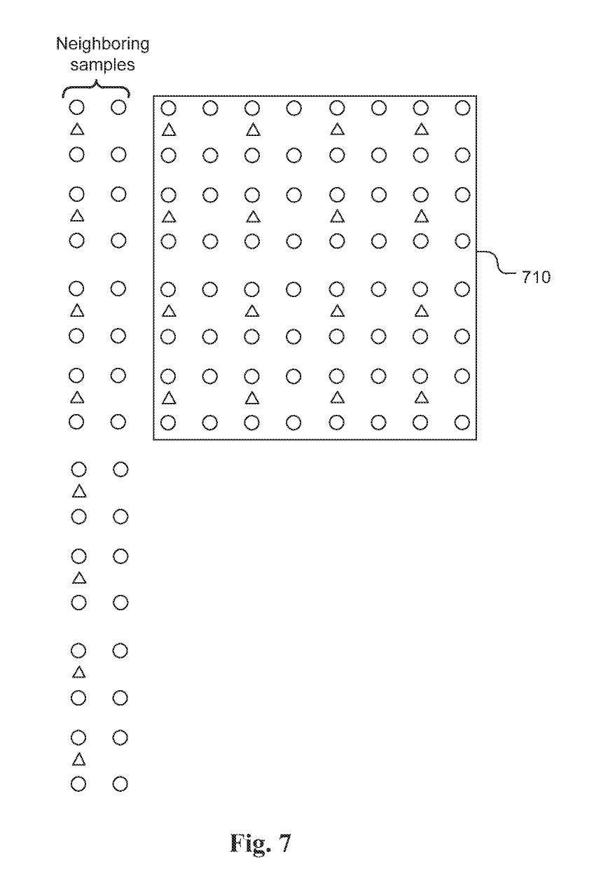

In yet another embodiment, parameters a and b are derived from left and bottom neighbouring chroma samples and corresponding luma samples. This extended mode is called LM_LEFT_BOTTOM mode. FIG. 7 illustrates an example of LM_LEFT_BOTTOM mode for a 4×4 chroma block 710. As shown in FIG. 7, the “left and bottom” neighbouring chroma samples (shown as triangles) and corresponding luma samples (shown as circles) refer to the left area on the left side of the current chroma block 710 and the area extending from the bottom of the left area in this disclosure.

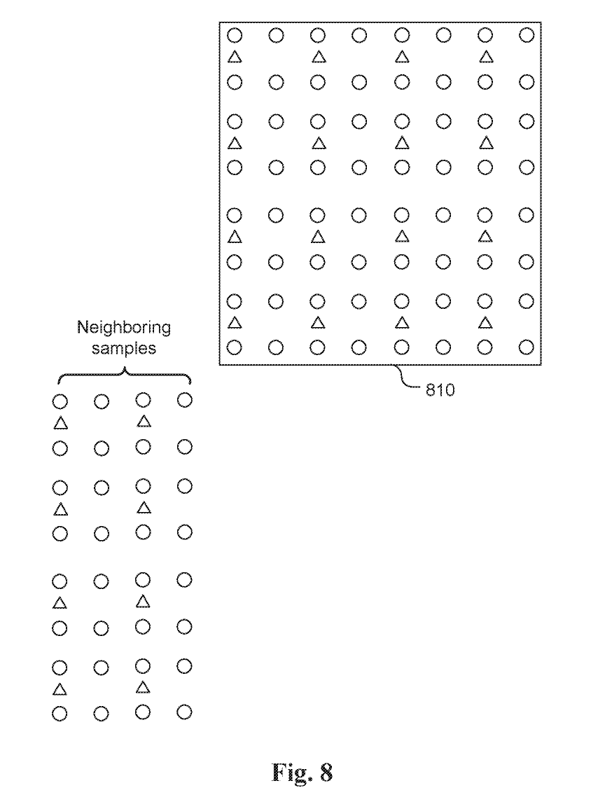

In yet another embodiment, parameters a and b are derived from bottom neighbouring chroma samples and corresponding luma samples. This extended mode is called LM_BOTTOM mode. FIG. 8 illustrates an example of LM_BOTTOM mode for a 4×4 chroma block 810. As shown in FIG. 8, the “bottom” neighbouring chroma samples (shown as triangles) and corresponding luma samples (shown as circles) refer to the area extending from the bottom of the left area in this disclosure.

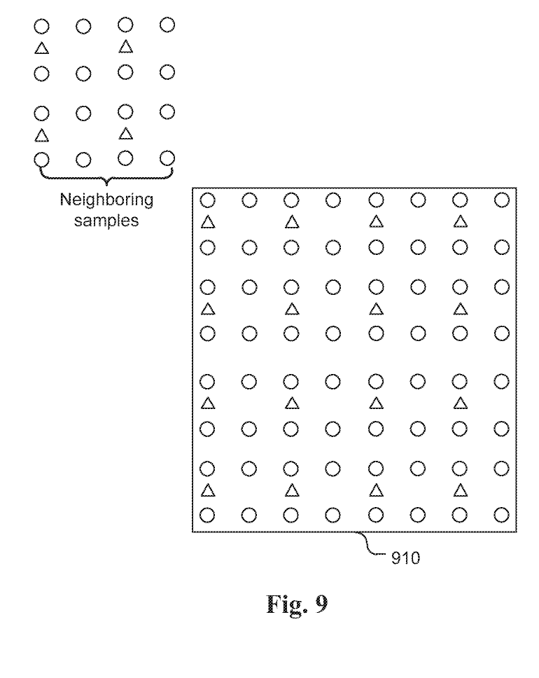

In yet another embodiment, parameters a and b are derived from left top neighbouring chroma samples and corresponding luma samples. This extended mode is called LM_LEFT_TOP mode. FIG. 9 illustrates an example of LM_LEFT_TOP mode for a 4×4 chroma block 910. As shown in FIG. 9, the “left top” neighbouring chroma samples (shown as triangles) and corresponding luma samples (shown as circles) refer to the area extending to the left from the top area in this disclosure.

The present invention also discloses a method of chroma Intra prediction by combining two different Intra prediction modes. According to this method, a chroma block is predicted by utilizing LM mode or its extended modes with one or more other modes together. In this case, the chroma block is coded by the ‘Fusion mode’. The use of fusion mode allows the use of a new type of chroma Intra prediction that is generated by combining two different chroma Intra predictions. For certain color video data, the combined chroma Intra prediction may perform better than any of two individual chroma Intra predictions. Since an encoder often uses a certain optimization process (e.g., rate-distortion optimization, RDO) to select a best coding mode for a current block, the combined chroma Intra prediction will be selected over the two individual chroma Intra predictions if the combined chroma Intra prediction achieves a lower R-D cost.

In one embodiment of fusion mode, a chroma block is predicted by mode L. For a sample (i,j) in this block, its prediction value with mode L is P^{L}(i,j). The chroma block is also predicted by another mode, named mode K other than the LM mode. For a sample (i,j) in this block, its prediction value with mode K is P^{K} (i,j). The final prediction for sample (i,j) denoted as P (i,j) in this block is calculated as shown in eq. (3):

P(i,j)=w1*P^{L}(i,j)+w2*P^{K}(i,j), (3)

where w1 and w2 are weighting coefficients corresponding to real number and w1+w2=1.

In eq. (3), w1 and w2 are real value. The final prediction P (i,j) may have to be calculated using floating point operations. In order to simplify P (i,j) computation, integer operations are preferred. Accordingly, in another embodiment, the final prediction P (i,j) is calculated as shown in eq. (4):

P(i,j)−(w1*P^{L}(i,j)+w2*P^{K}(i,j)+D)>>S, (4)

where w1, w2, D and S are integers, S>=1, and w1+w2=1<<S. In one example, D is 0. In another example, D is 1<<(S−1). According to eq. (4), the final prediction P (i,j) may be calculated using integer multiplication, addition and arithmetic right shift.

In yet another embodiment, the final prediction P (i,j) is calculated as shown in eq. (5):

P(i,j)−(P^{L}(i,j)+P^{K}(i,j)>>1. (5)

In yet another embodiment, the final prediction P (i,j) is calculated as shown in eq. (6), where the final prediction P(i,j) is calculated as the sum of P^{L}(i,j)and P^{K}(i,j) followed by right-shift-by-one as shown in eq. (6):

P(i,j)=(P^{L}(i,j)+P^{K}(i,j))>>1. (6)

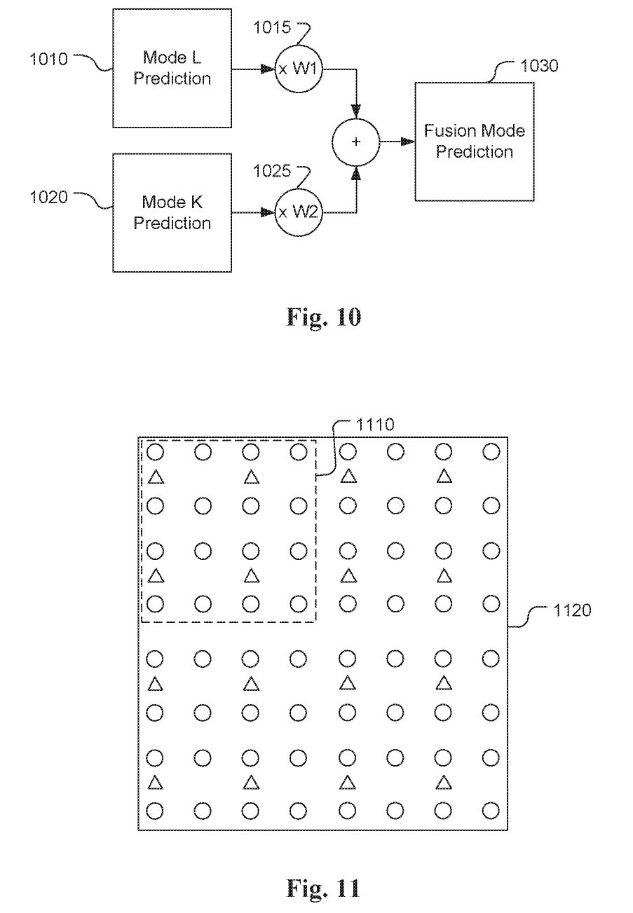

FIG. 10 illustrates an example of the Fusion mode prediction process, where the Fusion mode prediction 1030 is generated by linearly combining mode L prediction 1010 and mode K prediction 1020 with respective weighting factors (also referred as the weighting coefficients), w1 (1015) and w2 (1025). In an embodiment, the weighting coefficients w1 (1015) and w2 (1025) are position dependent.

For example, mode L may correspond to LM mode, LM_TOP mode, LM_LEFT mode, LM_TOP_RIGHT mode, LM_RIGHT mode, LM_LEFT_BOTTOM mode, LM_BOTTOM mode, LM_LEFT_TOP mode, or LM_CbCr mode.

On the other hand, mode K can be any angular mode with a prediction direction, DC mode, Planar mode, Planar_Ver mode or Planar_Hor mode, the mode used by the luma component of the current block, the mode used by Cb component of the current block, or the mode used by Cr component of the current block.

In another example, mode K corresponds to the mode used by the luma component of any sub-block in the current block. FIG. 11 illustrates an exemplary sub-block 1110 in the current block 1120, where the Intra prediction mode of sub-block 1110 for the luma component is used as the mode K Intra prediction for deriving the Fusion mode prediction.

If a chroma block is predicted by the LM mode or an extended mode and the colour format is non-4:4:4, there can be more than one option to map a chroma sample value (C) to its corresponding luma value (Y) in the linear model C=a*Y+b.

In one embodiment, LM modes or its extended modes with different mapping from C to its corresponding Y are regarded as different LM modes, denoted as LM_Phase_X for X from 1 to N, where N is the number of mapping methods from C to its corresponding Y.

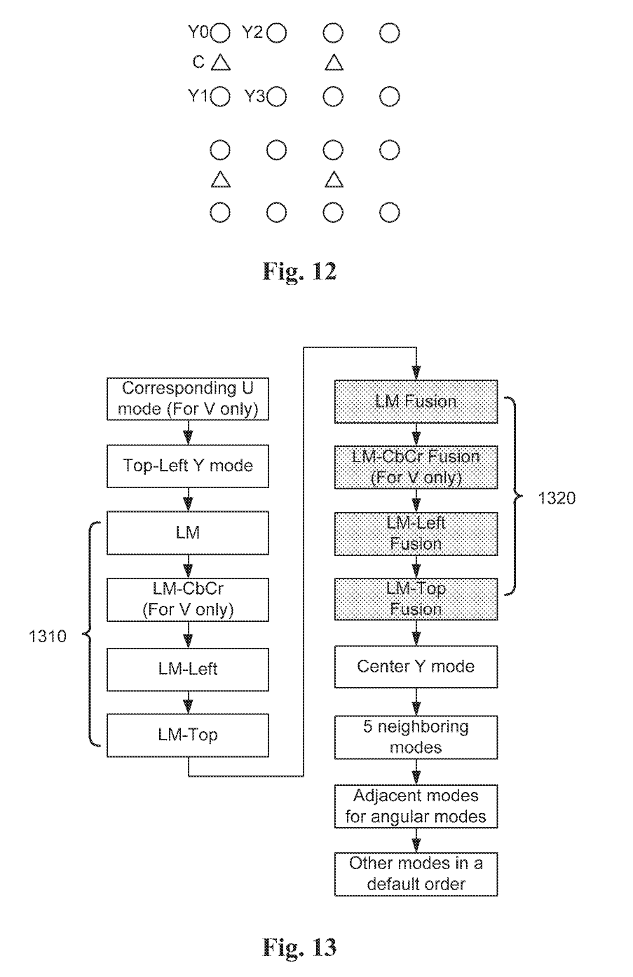

Some exemplary mappings for the colour format 4:2:0 in FIG. 12 are disclosed as follows:

a. Y=Y0

b. Y=Y1

c. Y=Y2

d. Y=Y3

e. Y=(Y0+Y1)/2

f. Y=(Y0+Y2)/2

g. Y=(Y0+Y3)/2

h. Y=(Y1+Y2)/2

i. Y=(Y1+Y3)/2

j. Y=(Y2+Y3)/2

k. Y=(Y0+Y1+Y2+Y3)/4

For example, two mapping methods can be used. For the first mapping method, mode LM_Phase_1, the corresponding luma value (Y) is determined according to Y=Y0. For the second mapping method, mode LM_Phase_2, the corresponding luma value (Y) is determined according to Y=Y1. The use of multi_phase mode allows alternative mappings from a chroma sample to different luma samples for chroma Intra prediction. For certain color video data, the multi_phase chroma Intra prediction may perform better than a single fixed mapping. Since an encoder often uses a certain optimization process (e.g., rate-distortion optimization, RDO) to select a best coding mode for a current block, the multi_phase chroma Intra prediction can provide more mode selections over the conventional single fixed mapping to improve the coding performance.

To code the chroma Intra prediction mode for a chroma block, LM Fusion mode is inserted into the code table after LM modes according to one embodiment of the present invention. Therefore, the codeword for an LM Fusion mode is always longer than or equal to the codewords for LM and its extension modes. An example code table order is demonstrated in FIG. 13, where the “Corresponding U mode (For V only)” mode is inserted into the beginning location of the code table and “Other modes in a default order” is inserted at the end of the code table. As shown in FIG. 13, four LM Fusion modes 1320 indicated by dot-filled areas are placed after LM modes 1310.

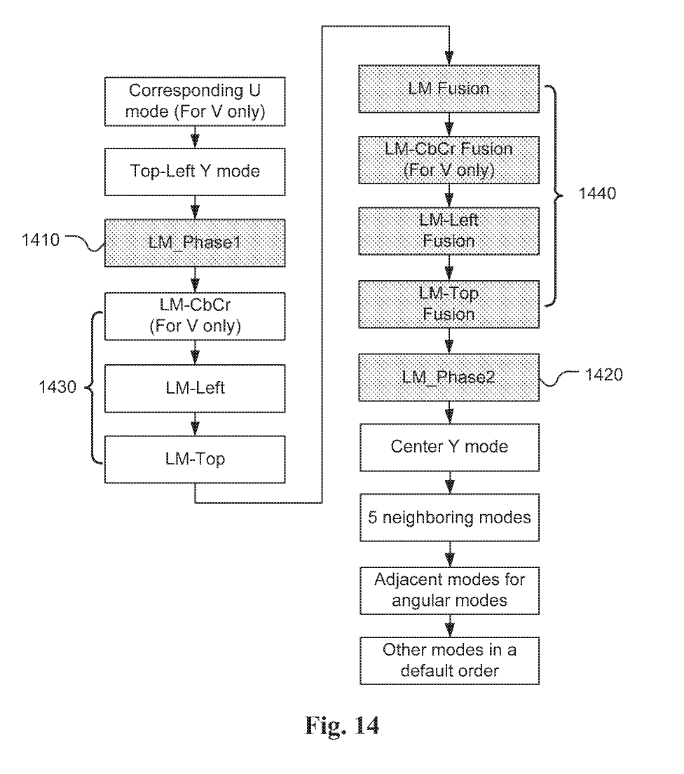

To code the chroma Intra prediction mode according to another embodiment of the present invention, LM_Phase_1 mode 1410 is inserted into the code table to replace the original LM mode as shown in FIG. 14. LM_Phase_2 mode 1420 is put into the code table after LM modes 1430 and LM Fusion modes 1440. Therefore, the codeword for LM_Phase_2 mode is longer than or equal to the codewords for LM and its extension modes. Also, the codeword for LM_Phase_2 mode is longer than or equal to the codewords for LM Fusion and its extension modes.

The method of extended neighbouring areas for deriving parameters of the LM mode, the method of Intra prediction by combining two Intra prediction modes (i.e.

fusion mode) and the multi-phase LM mode for non-444 colour format can be combined. For example, one or more multi-phase LM modes can be used for the fusion mode.

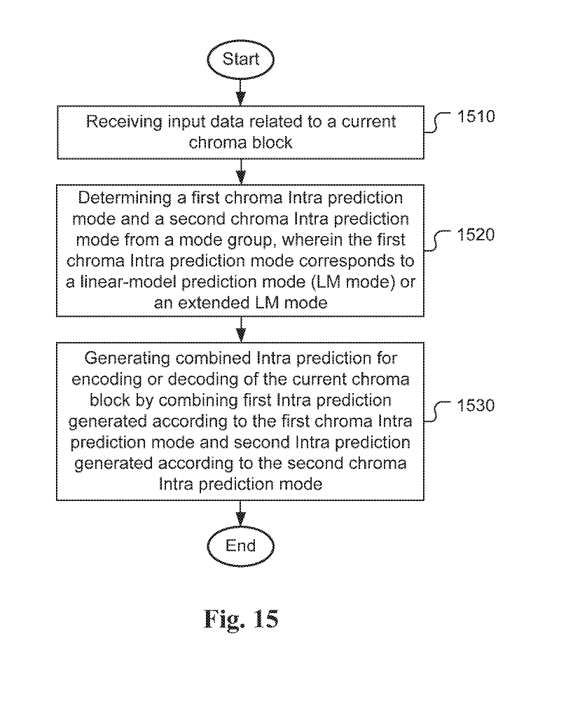

FIG. 15 illustrates an exemplary flowchart for fusion mode Intra prediction according to an embodiment of the present invention. Input data related to a current chroma block is received in step 1510. A first chroma Intra prediction mode and a second chroma Intra prediction mode from a mode group are determined in step 1520. In an embodiment, the first chroma Intra prediction mode corresponds to a linear-model prediction mode (LM mode) or an extended LM mode. Combined Intra prediction for encoding or decoding of the current chroma block is generated by combining first Intra prediction generated according to the first chroma Intra prediction mode and second Intra prediction generated according to the second chroma Intra prediction mode in step 1530. As mentioned earlier, the use of combined chroma Intra prediction may perform better than any of two individual chroma Intra predictions.

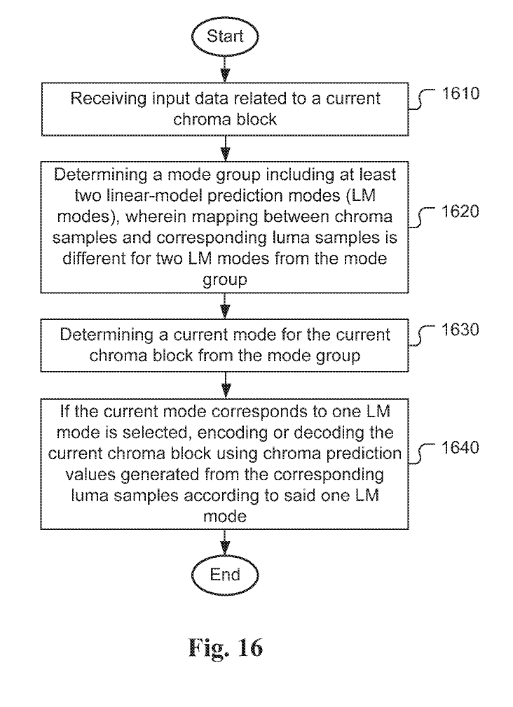

FIG. 16 illustrates an exemplary flowchart for multi-phase Intra prediction according to an embodiment of the present invention. Input data related to a current chroma block is received in step 1610. A mode group including at least two linear-model prediction modes (LM modes) is determined in step 1620, where mapping between chroma samples and corresponding luma samples is different for two LM modes from the mode group. A current mode for the current chroma block from the mode group is determined in step 1630. If the current mode corresponds to one LM mode is selected, the current chroma block is encoded or decoded using chroma prediction values generated from the corresponding luma samples according to said one LM mode in step 1640. As mentioned earlier, the use of multi_{A}phase mode allows alternative mappings from a chroma sample to different luma samples for chroma Intra prediction and to improve the coding performance.

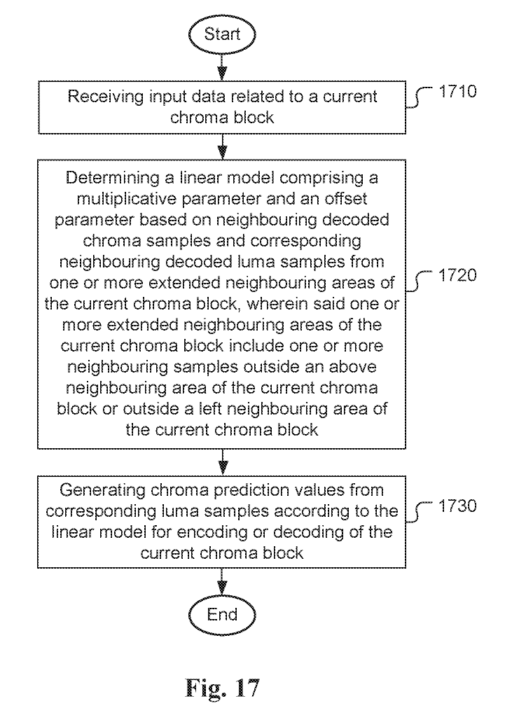

FIG. 17 illustrates an exemplary flowchart for Intra prediction using extended neighbouring area according to an embodiment of the present invention. Input data related to a current chroma block is received in step 1710. A linear model comprising a multiplicative parameter and an offset parameter is determined based on neighbouring decoded chroma samples and corresponding neighbouring decoded luma samples from one or more extended neighbouring areas of the current chroma block as shown in step 1720. Said one or more extended neighbouring areas of the current chroma block include one or more neighbouring samples outside an above neighbouring area of the current chroma block or outside a left neighbouring area of the current chroma block. Chroma prediction values are generated from corresponding luma sample according to the linear model for encoding or decoding of the current chroma block as shown in step 1730. As mentioned earlier, the use of extended neighbouring area(s) can derive better parameters a and b and to achieve better Intra prediction. Accordingly, the coding performance for chroma Intra prediction using extended neighbouring area(s) can be improved.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of Intra prediction for a chroma component performed by a video coding system, the method comprising:
receiving input data related to a current chroma block;
determining a first chroma Intra prediction mode and a second chroma Intra prediction mode from a mode group, wherein the first chroma Intra prediction mode corresponds to a linear-model prediction mode (LM mode) or an extended LM mode; and
generating combined Intra prediction for encoding or decoding of the current chroma block by combining first Intra prediction generated according to the first chroma Intra prediction mode and second Intra prediction generated according to the second chroma Intra prediction mode.

2. The method of claim 1, wherein the second chroma Intra prediction mode belongs to an Intra prediction mode group excluding any linear-model prediction mode (LM mode) that generates a chroma prediction value based on a reconstructed luma value using a linear model.

3. The method of claim 1, wherein the combined Intra prediction is generated using a weighted sum of the first Intra prediction and the second Intra prediction.

4. The method of claim 3, wherein the combined Intra prediction is calculated using integer operations including multiplication, addition and arithmetic shift to avoid a need for a division operation.

5. The method of claim 4, wherein the combined Intra prediction is calculated using a sum of the first Intra prediction and the second Intra prediction followed by a right-shift by one operation.

6. The method of claim 3, wherein weighting coefficient of the weighted sum is position dependent.

7. The method of claim 1, wherein the extended LM mode belongs to a mode group including LM_TOP mode, LM_LEFT mode, LM_TOP_RIGHT mode, LM_RIGHT mode, LM_LEFT_BOTTOM mode, LM_BOTTOM mode, LM_LEFT_TOP mode and LM_CbCr mode.

8. The method of claim 1, wherein the second chroma Intra prediction mode belongs to a mode group including angular modes, DC mode, Planar mode, Planar_Ver mode, Planar_Hor mode, a first mode used by a current luma block corresponding to the current chroma block, a second mode used by a sub-block of the current luma block, and a third mode used by a previous processed chroma component of the current chroma block.

9. The method of claim 1, wherein a fusion mode is included in an Intra prediction candidate list, wherein the fusion mode indicates that the first chroma Intra prediction mode and the second chroma Intra prediction mode are used and the combined Intra prediction is used for the encoding or decoding of the current chroma block.

10. The method of claim 9, wherein the fusion mode is inserted in a location of the Intra prediction candidate list after all linear-model prediction modes (LM modes), and wherein a codeword of the fusion mode is not shorter than a codeword of any LM mode.

11. The method of claim 9, wherein the mode group further includes a first linear-model prediction mode (LM mode) and a second LM mode, and mapping between chroma samples and corresponding luma samples is different between the first LM mode and the second LM mode; and wherein the first LM mode is inserted into the Intra prediction candidate list to replace a regular LM mode, the second LM mode is inserted into the Intra prediction candidate list at a location after the regular LM mode and the fusion mode.

12. An apparatus for Intra prediction of a chroma component performed by a video coding system, the apparatus comprising one or more electronic circuits or processors arranged to:
receive input data related to a current chroma block;
determine a first chroma Intra prediction mode and a second chroma Intra prediction mode, wherein the first chroma Intra prediction mode corresponds to a linear-model prediction mode (LM mode) or an extended LM mode; and
generate combined Intra prediction for encoding or decoding of the current chroma block by combining first Intra prediction generated according to the first chroma Intra prediction mode and second Intra prediction generated according to the second chroma Intra prediction mode.

13. A method of Intra prediction for a chroma component of non-444 colour video data performed by a video coding system, the method comprising:
receiving input data related to a current chroma block;
determining a mode group including at least two linear-model prediction modes (LM modes), wherein mapping between chroma samples and corresponding luma samples is different for two LM modes from the mode group;
determining a current mode for the current chroma block from the mode group; and
if the current mode corresponds to one LM mode is selected, encoding or decoding the current chroma block using chroma prediction values generated from the corresponding luma samples according to said one LM mode.

14. The method of claim 13, wherein the chroma component is from 4:2:0 colour video data and each current chroma sample has four collocated luma samples Y0, Y1, Y2 and Y3, and wherein Y0 is located above each current chroma sample, Y1 is located below each current chroma sample, Y2 is located above-right of each current chroma sample, and Y3 is located below-right of each current chroma sample.

15. The method of claim 14, wherein the corresponding luma sample associated with each current chroma sample corresponds to Y0, Y1, Y2, Y3, (Y0+Y1)/2, (Y0+Y2)/2, (Y0+Y3)/2, (Y1+Y2)/2, (Y1+Y3)/2, (Y2+Y3)/2, or (Y0+Y1+Y2+Y3)/4.

16. The method of claim 13, wherein the mode group includes a first linear-model prediction mode (LM mode) and a second LM mode, and wherein the corresponding luma sample associated with each current chroma sample corresponds to Y0 and Y1 for the first LM mode and the second LM mode respectively.

17. An apparatus for Intra prediction of a chroma component of non-444 colour video data performed by a video coding system, the apparatus comprising one or more electronic circuits or processors arranged to:
receive input data related to a current chroma block;
determine a mode group including at least two linear-model prediction modes (LM modes), wherein mapping between chroma samples and corresponding luma samples is different for two LM modes from the mode group;
determine a current mode for the current chroma block from the mode group; and
if the current mode corresponds to one LM mode is selected, encode or decode the current chroma block using chroma prediction values generated from the corresponding luma samples according to said one LM mode.

18. A method of Intra prediction for a chroma component performed by a video coding system, the method comprising:
receiving input data related to a current chroma block;
determining a linear model comprising a multiplicative parameter and an offset parameter based on neighbouring decoded chroma samples and corresponding neighbouring decoded luma samples from one or more extended neighbouring areas of the current chroma block, wherein said one or more extended neighbouring areas of the current chroma block include one or more neighbouring samples outside an above neighbouring area of the current chroma block or outside a left neighbouring area of the current chroma block; and
generating chroma prediction values from corresponding luma samples according to the linear model for encoding or decoding of the current chroma block.

19. The method of claim 18, wherein said one or more extended neighbouring areas of the current chroma block correspond to top and right, right, left and bottom, bottom, or left top neighbouring chroma samples and corresponding luma samples.

20. An apparatus for Intra prediction of a chroma component performed by a video coding system, the apparatus comprising one or more electronic circuits or processors arranged to:
receive input data related to a current chroma block;
determine a linear model comprising a multiplicative parameter and an offset parameter based on neighbouring decoded chroma samples and corresponding neighbouring decoded luma samples from one or more extended neighbouring areas of the current chroma block, wherein said one or more extended neighbouring areas of the current chroma block include one or more neighbouring samples outside an above neighbouring area of the current chroma block or outside a left neighbouring area of the current chroma block; and
generate chroma prediction values from corresponding luma samples according to the linear model for encoding or decoding of the current chroma block.
